(19) United States
(12) Patent Application Publication
(10) Pub. No.: US 2016/0332892 A1
(43) Pub. Date: Nov. 17, 2016

(54) DEVICE AND METHOD FOR DETOXIFYING PLASMA-TREATED WATER CONTAINING HYDROGEN PEROXIDE

(71) Applicant: Panasonic Intellectual Property Management Co., Ltd., Osaka (JP)

(72) Inventors: MASAKI FUJIKANE, Osaka (JP); MARI ONODERA, Osaka (JP); MASAHIRO ISEKI, Osaka (JP)

(21) Appl. No.: 15/141,418

(22) Filed: Apr. 28, 2016

(30) Foreign Application Priority Data
May 15, 2015 (JP) 2015-100439

(51) Int. Cl. C02F 1/20; C02F 1/28; B01D 19/00; C02F 1/36

(52) U.S. Cl. CPC C02F 1/20; C02F 1/36; C02F 1/283; B01D 19/0078; B01D 19/0031; C02F 2101/10

(57) ABSTRACT

A method according to an aspect of the present disclosure includes filtering plasma-treated water containing hydrogen peroxide which has been produced by generation of plasma in or near water; and applying ultrasound to the plasma-treated water after the filtering.

### BACKGROUND

1. Technical Field

The present disclosure relates to a device and a method for detoxifying plasma-treated water.

2. Description of the Related Art

Devices and methods in which water is, for example, purified or sterilized by using plasma are known. For example, Japanese Unexamined Patent Application Publication No. 2009-255027 discloses a device and a method in which active species such as hydrogen peroxide are produced by using plasma and the active species are used for killing microorganisms and bacteria contained in water.

### SUMMARY

A method according to an aspect of the present disclosure comprises: filtering plasma-treated water containing hydrogen peroxide which has been produced by generation of plasma in or near water; and applying ultrasound to the plasma-treated water after the filtering.

By this method, hydrogen peroxide contained in plasma-treated water may be removed.

It should be noted that comprehensive or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram illustrating an example of a liquid treatment apparatus according to an embodiment;

FIG. 2A is a diagram illustrating an example of a first metal electrode according to an embodiment;

FIG. 2B is a diagram illustrating another example of a first metal electrode according to an embodiment;

FIG. 3 is a diagram illustrating an example of a device for detoxifying plasma-treated water according to an embodiment;

FIG. 4 is a flowchart illustrating an example operation of a liquid treatment apparatus according to an embodiment;

FIG. 5 is a flowchart illustrating an example operation of a device for detoxifying plasma-treated water according to an embodiment; and

FIG. 6 is a diagram for explaining the advantageous effects of a device for detoxifying plasma-treated water according to an embodiment.

### DETAILED DESCRIPTION

### Overview of Embodiments

Hydrogen peroxide is likely to remain in water that has been, for example, purified or sterilized by using plasma (hereinafter, referred to as “plasma-treated water”). Although hydrogen peroxide, which has an oxidizing power, is used for purification or sterilization, hydrogen peroxide remaining in water is disadvantageous in some cases. For example, it is not possible to use the plasma-treated water containing hydrogen peroxide as drinking water. For example, when such plasma-treated water is discharged into sea, or a river, hydrogen peroxide adversely affects aquatic animals and plants.

Accordingly, one non-limiting and exemplary embodiment provides a device and a method for detoxifying plasma-treated water by which hydrogen peroxide contained in the plasma-treated water may be removed.

A method for detoxifying plasma-treated water according to an aspect of the present disclosure may include filtering plasma-treated water containing hydrogen peroxide through active carbon, the plasma-treated water being water treated with plasma generated near the water or so as to come into contact with the water; and applying ultrasound to the plasma-treated water filtered in the filtering step.

By the above-described method in which plasma-treated water is filtered through active carbon and ultrasound is applied to the filtered plasma-treated water, hydrogen peroxide contained in the plasma-treated water may be removed.

For example, the plasma-treated water containing hydrogen peroxide may include microbubbles having a diameter of 1 μm or more, and, in the filtering step, the active carbon may remove the microbubbles by using pores formed in the active carbon.

In such a case, it is possible to remove nanobubbles by applying ultrasound to the filtered plasma-treated water without the negative impact produced by the microbubbles since the microbubbles contained in the plasma-treated water have been removed when the plasma-treated water was filtered through the active carbon. Consequently, both microbubbles and nanobubbles which generate hydrogen peroxide with time may be removed. As a result, hydrogen peroxide contained in the plasma-treated water may be removed.

For example, the plasma may be generated inside a bubble formed by a gas fed to the water.

In this case, it is possible to remove hydrogen peroxide contained in water treated with plasma generated with high efficiency.

A device for detoxifying plasma-treated water according to an aspect of the present disclosure may include active carbon disposed at a point through which plasma-treated water containing hydrogen peroxide passes, the plasma-treated water being water treated with plasma generated near the water or so as to come into contact with the water; and an ultrasonic treatment unit disposed downstream of the active carbon, the ultrasonic treatment unit applying ultrasound to the plasma-treated water filtered through the active carbon.

The above-described device for detoxifying plasma-treated water enables the plasma-treated water to be filtered through the active carbon and hydrogen peroxide contained in the filtered plasma-treated water to be removed by using ultrasound.

Specific examples of the embodiments are described below with reference to the attached drawings.

The following embodiments are all comprehensive or specific examples. All numbers, shapes, materials, components, the arrangements of the components, and the connections between the components, steps, and the orders of the steps described in the following embodiments are merely examples and are not intended to limit the scope of the present disclosure. Among the components described in the following embodiments, components that are not described in the independent claims are described as optional components.

### Embodiments

### [1. Structure of Liquid Treatment Apparatus]

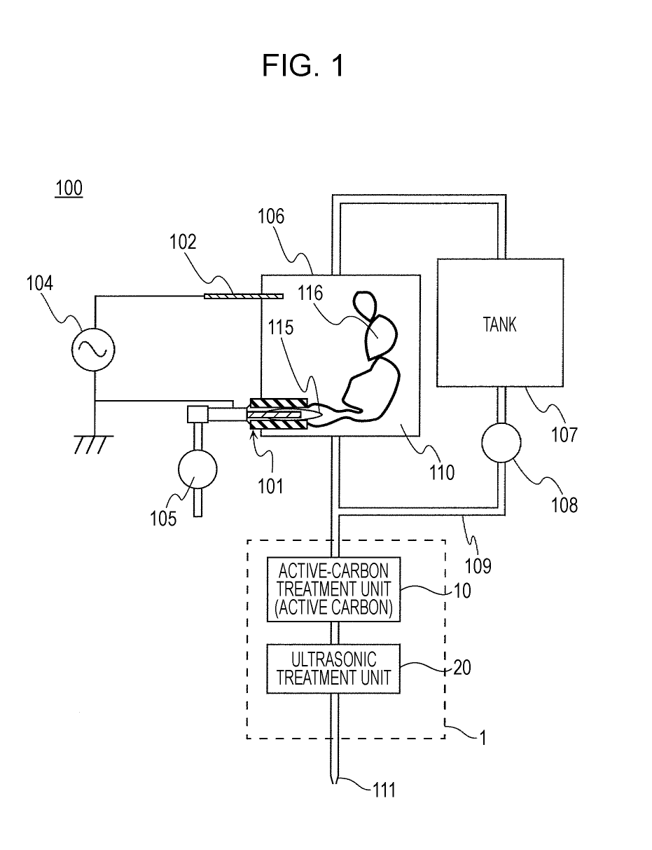

A liquid treatment apparatus 100 according to an embodiment is described with reference to FIG. 1.

FIG. 1 illustrates the structure of the liquid treatment apparatus 100 according to the embodiment.

The liquid treatment apparatus 100 brings water into contact with plasma to purify or sterilize the water, and then detoxifies the plasma-treated water. Alternatively, the liquid treatment apparatus 100 may generate plasma near the water to produce active species, and thereby bring a gas containing the active species into contact with the water. Hereinafter, purification or sterilization of water which is performed by using plasma generated near the water or so as to come into contact with the water may be referred to as “plasma treatment”; a liquid that is to be treated with plasma may be referred to as “water to be plasma-treated”; and a liquid that has been treated with plasma may be referred to as “plasma-treated water”. In the present embodiment, “water 110” is an example of the water to be plasma-treated.

The liquid treatment apparatus 100 includes a first metal electrode 101 disposed inside a reaction tank 106 containing water 110 to be plasma-treated; a second metal electrode 102 disposed inside the reaction tank 106; a feed pump 105 used for feeding a gas; and a power supply 104 used for applying a voltage between the first metal electrode 101 and the second metal electrode 102. The liquid treatment apparatus 100 also includes a tank 107, a circulation pump 108, a pipe 109, and a water intake 111. The liquid treatment apparatus 100 further includes a detoxification device 1 for detoxifying the plasma-treated water.

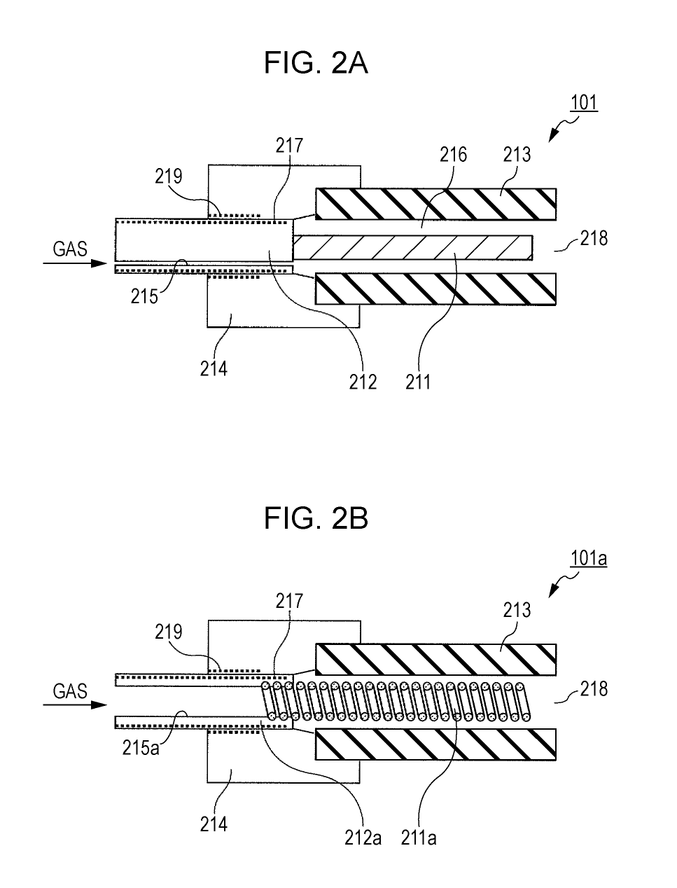

The first metal electrode 101 is disposed inside the reaction tank 106 so as to penetrate one of the walls of the reaction tank 106. An end of the first metal electrode 101 is located inside the reaction tank 106. The first metal electrode 101 is described in detail below with reference to FIG. 2A.

Similarly to the first metal electrode 101, the second metal electrode 102 is disposed inside the reaction tank 106 so as to penetrate one of the walls of the reaction tank 106. An end of the second metal electrode 102 is located inside the reaction tank 106. The second metal electrode 102 is, for example, a cylindrical electrode. An end of the second metal electrode 102 is arranged to come into contact with the water 110 to be plasma-treated in the reaction tank 106. The second metal electrode 102 may be composed of a conductive metal such as copper, aluminium, or iron.

The power supply 104 is connected between the first metal electrode 101 and the second metal electrode 102 and applies a predetermined voltage therebetween. Specifically, the power supply 104 applies a pulse voltage or an alternating voltage between the first metal electrode 101 and the second metal electrode 102. For example, the predetermined voltage may be a negative high-voltage pulse of 2 to 50 kV/cm and 1 Hz to 100 kHz. The waveform of the voltage may be, for example, a pulsed waveform, a half-sine waveform, or a sine waveform. The amount of current that flows between the pair of electrodes is, for example, 1 mA to 3 A. Specifically, the power supply 104 applies a pulse voltage having a peak voltage of 4 kV, a pulse width of 1 μs, and a frequency of 30 kHz between the first metal electrode 101 and the second metal electrode 102. The input power of the power supply 104 is, for example, 30 W.

The feed pump 105 is connected to the first metal electrode 101 and feeds a gas to the water 110 through the first metal electrode 101. The gas is used for forming a bubble 116. Examples of the feed gas include air, He, Ar, and O₂. Subsequently, upon the power supply 104 applying a voltage between the first metal electrode 101 and the second metal electrode 102, plasma 115 is generated inside the bubble 116. Alternatively, the feed pump 105 may start feeding the gas to the water 110 at the same time as, for example, the power supply 104 starts the application of voltage.

The reaction tank 106 is filled with the water 110 to be plasma-treated. The first metal electrode 101 and the second metal electrode 102 are disposed in one of the walls of the reaction tank 106. The reaction tank 106 is connected to the tank 107 and the detoxification device 1 with the pipe 109 in which the circulation pump 108 is disposed. The water 110 is circulated between the reaction tank 106 and the tank 107 with the circulation pump 108 and fed to the detoxification device 1. The rate of circulation of the water 110 is set appropriately depending on the rate of purification performed using the plasma 115, the volume of the reaction tank 106, and the flow rate of the water 110 fed to the detoxification device 1.

The tank 107 stores the water 110 to be plasma-treated. Since the amount of water 110 that circulates between the reaction tank 106 and the tank 107 is reduced by the amount of that fed to the detoxification device 1, water 110 to be plasma-treated may be added to the tank 107 from an external source.

The circulation pump 108 causes the water 110 to circulate between the reaction tank 106 and the tank 107.

The pipe 109 is a pipe through which the water 110 flows from the tank 107 to the reaction tank 106 and through which water treated with plasma in the reaction tank 106 flows from the reaction tank 106 to the detoxification device 1 or the tank 107. The pipe 109 is constituted by pipe-like members such as a pipe, a tube, or a hose. The pipe 109 bifurcates into two pipes at a junction located between the reaction tank 106, the tank 107, and the detoxification device 1. For example, a valve may be disposed at the junction of the pipe 109, and whether the plasma-treated water is fed to the detoxification device 1 or circulated to the tank 107 may be switched by using the valve.

The water 110 is, for example, water that is to be used as drinking water after being treated with plasma or water that is to be discharged into sea or a river after being treated with plasma.

The water intake 111 serves as, for example, as a water intake through which the plasma-treated water detoxified in the detoxification device 1 is taken. In the case where the water 110 is the water that is to be discharged into sea or a river after being treated with plasma, the water intake 111 serves as a water outlet.

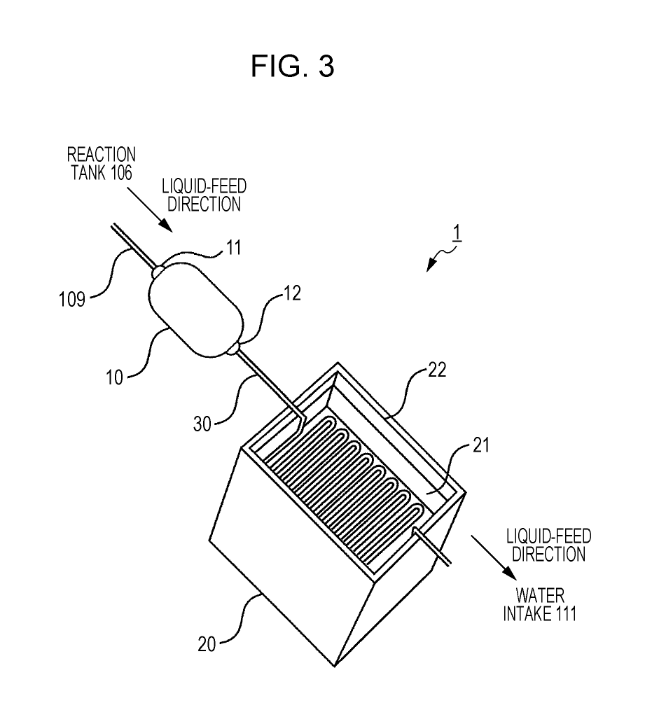

The detoxification device 1 is a device for detoxifying the plasma-treated water. The detoxification device 1 includes an active-carbon treatment unit 10 and an ultrasonic treatment unit 20. The detoxification device 1 is described below in detail with reference to FIG. 3.

### [1-1. First Metal Electrode]

The first metal electrode 101 is described below in detail with reference to FIG. 2A.

FIG. 2A illustrates an example of the first metal electrode 101 according to an embodiment.

As illustrated in FIG. 2A, the first metal electrode 101 includes a metal electrode portion 211, a metal thread portion 212, an insulator 213, and a holding block 214. An end of the first metal electrode 101 is located inside the reaction tank 106, and the other end is held by the holding block 214 and connected to the feed pump 105.

The metal electrode portion 211 is disposed inside the reaction tank 106 as illustrated in FIG. 1. Specifically, the first metal electrode 101 is exposed to the water 110 in the reaction tank 106. The metal electrode portion 211 is integrated with the metal thread portion 212 by being press-fitted into the metal thread portion 212. The metal electrode portion 211 is arranged not to protrude outward from an opening 218 of the insulator 213.

The metal electrode portion 211 is, for example, a rod-like member having a diameter of 0.95 mm and is composed of tungsten. The diameter of the metal electrode portion 211 is not limited to this and may be set such that the plasma 115 can be generated. The diameter of the metal electrode portion 211 may be, for example, 2 mm or less. The material of the metal electrode portion 211 is not limited to tungsten, and any other metal having resistance to plasma may be used. The metal electrode portion 211 may be composed of, for example, copper, aluminium, iron, or an alloy thereof, although the durability of the metal electrode portion 211 may be degraded. Optionally, a conductive substance may be deposited on a part of the surface of the metal electrode portion 211, and thermal spraying may be performed. By the thermal spraying treatment, for example, an yttrium oxide coating which has an electric resistivity of 1 to 30 Ωcm can be formed on the metal electrode portion 211. The yttrium oxide spraying treatment may increase the service life of the electrode.

The metal thread portion 212 is, for example, a rod-like member having a diameter of 3 mm and is composed of iron. The diameter of the metal thread portion 212 is not limited to this and may be set, for example, so as to be larger than the diameter of the metal electrode portion 211. The material of the metal thread portion 212 is not limited to iron; any material commonly used for making threads, such as copper, zinc, aluminium, tin, or brass may be used. The materials and the sizes of the metal thread portion 212 and the metal electrode portion 211 may be the same as or different from each other. The metal thread portion 212 is physically connected and fixed to the holding block 214 described below and electrically connected to the power supply 104.

As described above, by using a metal having high resistant to plasma as a material of the metal electrode portion 211 and a metal having high workability as a material of the metal thread portion 212, a first metal electrode 101 having high resistance to plasma and consistent properties can be produced at a low cost.

A through-hole 215 is formed in the metal thread portion 212. The through-hole 215 communicates with a space 216 surrounded by the insulator 213. A gas is fed from the feed pump 105 to the space 216 through the through-hole 215. The gas fed through the through-hole 215 covers the metal electrode portion 211

In the case where the metal thread portion 212 has only one through-hole 215, the through-hole 215 is formed such that a gas is fed from the lower part of the metal electrode portion 211 in the direction of gravity. This makes it easy to cover the metal electrode portion 211 with the gas, since the gas moves in a direction opposite to the direction of gravity. The diameter of the through-hole 215 is, for example, 0.3 mm.

A thread 217 is formed in the outer periphery of the metal thread portion 212. The thread 217 is, for example, a male thread. The thread 217 is threadably engaged with the thread 219 described below. Since the power supply 104 includes a structure capable of being threadably engaged with the thread 217, the power supply 104 can be threadably engaged with the metal thread portion 212. This enables the power supply 104 and the metal thread portion 212 to be electrically connected to each other with a consistent contact resistance. Since the feed pump 105 includes a structure capable of being threadably engaged with the thread 217, the feed pump 105 can be threadably engaged with the metal thread portion 212. This enables the feed pump 105 to feed a gas in a consistent manner.

The insulator 213 is arranged so as to surround the metal electrode portion 211. The insulator 213 and the metal electrode portion 211 define a space 216 formed therebetween. The insulator 213 is, for example, a pipe-like member having an inner diameter of 1 mm. The insulator 213 is composed of, for example, an alumina ceramic, magnesia, quartz, or yttrium oxide.

The insulator 213 has an opening 218. The opening 218 controls the size of the bubble 116 formed in the water 110 in the reaction tank 106. The diameter of the opening 218 is, for example, equal to the inner diameter of the insulator 213, that is, 1 mm.

Although the opening 218 is formed in the end surface of the insulator 213 in FIG. 2A, the opening 218 may be formed in the side surface of the insulator 213. Alternatively, a plurality of openings 218 may be formed in the insulator 213.

The holding block 214 is used for holding the metal thread portion 212 and the insulator 213 in place. A thread 219 is formed in the holding block 214. The thread 219 is, for example, a female thread and threadably engaged with the thread 217 of the metal thread portion 212. Rotating the metal thread portion 212 enables the positional relationship between the insulator 213 and the metal electrode portion 211 to be adjusted.

Since the metal electrode portion 211 is covered with a gas fed from the feed pump 105 to the space 216 defined by the insulator 213 and the metal electrode portion 211 as described above, the metal electrode portion 211 does not come into direct contact with the water 110 in the reaction tank 106. This enables the metal electrode portion 211 to readily cause electrical discharge and to readily generate the plasma 115. When a gas is continuously fed to the space 216, a bubble 116 is formed in the water 110 to be plasma-treated. The bubble 116 is a columnar bubble having a size such that the opening 218 of the insulator 213 is covered with the bubble.

The liquid treatment apparatus 100 according to the embodiment may include, instead of the first metal electrode 101, the first metal electrode 101a illustrated in FIG. 2B.

FIG. 2B illustrates another example of the first metal electrode 101 according to the embodiment.

The first metal electrode 101 a illustrated in FIG. 2B differs from the first metal electrode 101 illustrated in FIG. 2A in that the first metal electrode 101a includes a metal electrode portion 211a and a metal thread portion 212a instead of the metal electrode portion 211 and the metal thread portion 212. The following description centers on the changes.

The metal electrode portion 211a is a hollow electrode. For example, the metal electrode portion 211a is a coiled electrode made of tungsten having an outer diameter of 0.99 mm. The metal electrode portion 211a is not limited to a coiled electrode and may be, for example, a hollow, rod-like electrode.

The metal thread portion 212a has a through-hole 215a having a diameter of, for example, 1 mm which is formed at the shaft center of the metal thread portion 212a . The metal electrode portion 211 a is fixed in place by, for example, being threadably engaged with the through-hole 215a.

As described above, in the first metal electrode 101 a illustrated in FIG. 2B, the diameter of the through-hole 215a can be increased. This increases ease of forming the through-hole 215a and consequently reduces the production cost.

In the case where plasma is generated near the water, the first metal electrode 101 and the second metal electrode 102 may be disposed above the surface of the water 110 to be plasma-treated in the reaction tank. In such a case, upon a voltage being applied between the first metal electrode 101 and the second metal electrode 102 to generate plasma, active species are produced in the gas-phase space above the water surface. The gas containing active species may be brought into contact with the water 110 to be plasma-treated. The term “near the water” used herein means at a region within a distance from the water surface at which active species produced by plasma are capable of coming into contact with the water, that is, for example, a region within 2 cm from the water surface.

### [1-2. Detoxification Device]

The detoxification device 1 is descried below in detail with reference to FIG. 3.

FIG. 3 illustrates an example of the detoxification device 1 according to an embodiment.

The detoxification device 1 includes an active-carbon treatment unit 10 and an ultrasonic treatment unit 20. The plasma-treated water flows, for example, through a pipe 30, that is a pipe-like member such as a pipe, a tube, or a hose, in the liquid-feed direction in a one-way manner so as to pass through the active-carbon treatment unit 10 and the ultrasonic treatment unit 20 in this order as illustrated in FIG. 3. The plasma-treated water is finally taken or discharged through the water intake 111.

The active-carbon treatment unit 10 is a container including active carbon disposed therein and, for example, an inlet 11 and an outlet 12. The active carbon is disposed at a point through which the plasma-treated water containing hydrogen peroxide passes. The inlet 11 is connected to, for example, the pipe 109, through which the plasma-treated water is introduced from the reaction tank 106 to the inside of the active-carbon treatment unit 10. However, the connection between the reaction tank 106 and the active-carbon treatment unit 10 is not limited to this; the reaction tank 106 and the active-carbon treatment unit 10 may be connected to each other in any suitable manner that enables the plasma-treated water to be introduced from the reaction tank 106 to the inside of the active-carbon treatment unit 10. In some cases, the inlet 11 may not be connected to the pipe 109. The outlet 12 is connected to, for example, a pipe 30, through which the plasma-treated water passed through the inside of the active-carbon treatment unit 10 is taken. The expression “the plasma-treated water is passed through the inside of the active-carbon treatment unit 10” herein means that the plasma-treated water is filtered through the active carbon disposed inside the active-carbon treatment unit 10. Although the active-carbon treatment unit 10 illustrated in FIG. 3 is a container including active carbon disposed inside the container, an inlet 11, and an outlet 12, the structure of the active-carbon treatment unit 10 is not limited to this. For example, the active-carbon treatment unit 10 may have any structure that enables the plasma-treated water to be filtered through active carbon.

The ultrasonic treatment unit 20, which is disposed downstream of the active-carbon treatment unit 10, applies ultrasound to the plasma-treated water which has been filtered through the active-carbon treatment unit 10. Specifically, the ultrasonic treatment unit 20 is, for example, an ultrasonic cleaning machine. The ultrasonic treatment unit 20 includes an ultrasound generator (not illustrated in the drawing) including an ultrasonic transducer and a tank 22 containing a liquid 21 (e.g., water or an organic solvent) through which ultrasound can propagate. The ultrasonic treatment unit 20 applies, for example, ultrasound having an output of 150 W and a frequency of 47 kHz to the liquid 21 contained in the tank 22. The pipe 30, which is connected to the outlet 12 of the active-carbon treatment unit 10, passes through the liquid 21 contained in the tank 22 of the ultrasonic treatment unit 20 by being folded a plurality of times in a zigzag manner as illustrated in FIG. 3. The plasma-treated water passes through the ultrasonic treatment unit 20 through the pipe 30. The plasma-treated water passed through the ultrasonic treatment unit 20 is taken or discharged through the water intake 111. In this embodiment, passing the plasma-treated water through the ultrasonic treatment unit 20 corresponds to applying ultrasound to the plasma-treated water by using the ultrasonic treatment unit 20. The number of times the pipe 30 is folded inside the tank 22 may be determined in accordance with the flow rate of the plasma-treated water that flows through the pipe 30, and the amount of time during which ultrasound is applied to the pipe 30. Thus, the ultrasonic treatment unit 20 applies ultrasound to the plasma-treated water by applying ultrasound to the pipe 30 through which the plasma-treated water flows. Although the ultrasonic treatment unit 20 illustrated in FIG. 3 applies ultrasound to the plasma-treated water via the pipe 30 that passes through the tank 22, the structure of the ultrasonic treatment unit 20 is not limited to this. For example, the ultrasonic treatment unit 20 may have any structure that enables ultrasound to be applied to the plasma-treated water. Although the active-carbon treatment unit 10 and the ultrasonic treatment unit 20 are connected to each other with the pipe 30 in FIG. 3, the connection between the active-carbon treatment unit 10 and the ultrasonic treatment unit 20 is not limited to this. The active-carbon treatment unit 10 and the ultrasonic treatment unit 20 may be connected to each other with any suitable member other than the pipe 30 which enables the plasma-treated water passed through the active-carbon treatment unit 10 to be fed to the ultrasonic treatment unit 20.

As described above, the detoxification device 1 is configured to cause the plasma-treated water to passe through the active-carbon treatment unit 10 and the ultrasonic treatment unit 20 in this order in an one-way manner.

### [2. Operation of Liquid Treatment Apparatus]

The operation of the liquid treatment apparatus 100 according to an embodiment is described below.

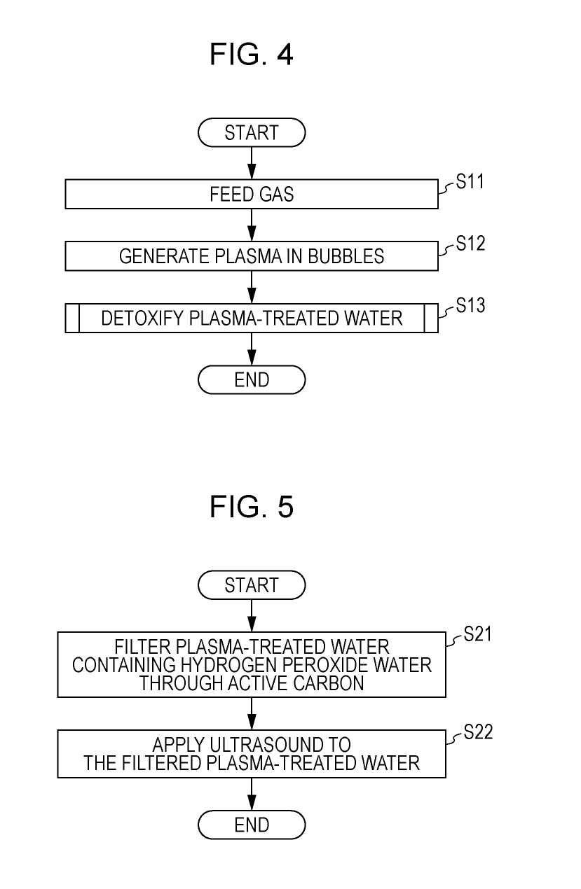

FIG. 4 is a flowchart illustrating the operation of the liquid treatment apparatus 100 according to the embodiment.

The feed pump 105 feeds a gas to the space 216 defined by the insulator 213 and the metal electrode portion 211 of the first metal electrode 101 through the through-hole 215 of the first metal electrode 101 (Step S11). The gas forms a bubble 116 in the water 110 to be plasma-treated. The bubble 116 covers the metal electrode portion 211. The bubble 116 becomes a single, large bubble that extends a certain distance from the opening 218 of the insulator 213 as illustrated in FIG. 1.

Upon the power supply 104 applying a voltage between the first metal electrode 101 and the second metal electrode 102, plasma 115 is generated from a region near the metal electrode portion 211 of the first metal electrode 101 toward the insides of the bubble 116 (Step S12). Since the second metal electrode 102 is in contact with the water 110 to be plasma-treated, the entirety of the water 110 has the same potential, and the interface between the bubble 116 and the water 110 can serve as a counter electrode. Therefore, forming large bubble 116 corresponds to forming a counter electrode having a large area in the water 110. This is why the large bubble 116 enables the plasma 115 to be generated not only at the end of the first metal electrode 101 but also inside the bubble 116 widely. When the plasma 115 generated inside the bubble 116 is brought into contact with the water 110 to be plasma-treated, active species such as hydrogen peroxide are produced. In this manner, the water 110 is treated with plasma to produce plasma-treated water containing hydrogen peroxide. The distance between the first metal electrode 101 and the second metal electrode 102 may be set appropriately. For example, it is possible to generate plasma 115 even when the distance between the first metal electrode 101 and the second metal electrode 102 is more than 50 mm.

As described above, the feed pump 105 feeds a gas into a space in the vicinity of the metal electrode portion 211 to produce a bubble 116 covering the metal electrode portion 211. This makes it easy to perform electrical discharge by the power supply 104 applying a voltage between the first metal electrode 101 and the second metal electrode 102. The plasma 115 is generated inside the bubble 116. Thus, the plasma 115 is generated not only at the end of the first metal electrode 101 but also inside the bubble 116 widely. This enables a large amount of active species such as hydrogen peroxide to be produced and makes it possible to treat the water 110 with plasma with efficiency.

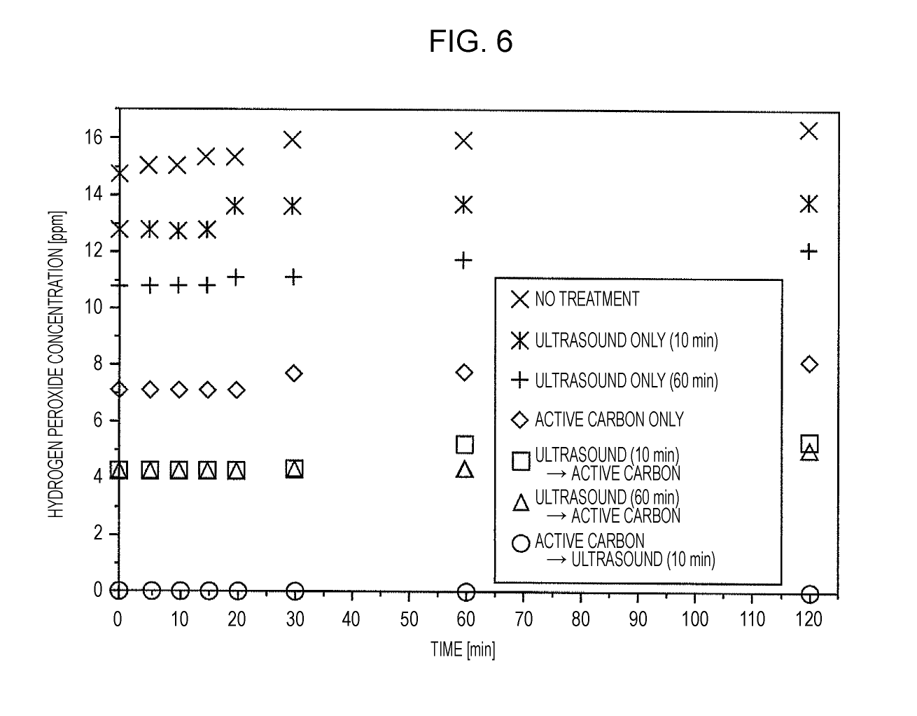

The detoxification device 1 detoxifies the plasma-treated water containing hydrogen peroxide (Step S13). The operation in Step S13 are described below in detail with reference to FIG. 5.

### [2-1. Operation of Detoxification Device]

FIG. 5 is a flowchart illustrating the operation of the detoxification device 1 according to an embodiment.

The active-carbon treatment unit 10 filters the plasma-treated water containing hydrogen peroxide through active carbon (Step S21).

In this step, the active carbon can decompose unstable compounds such as hydrogen peroxide into stable compounds. In this case, the active carbon can serve as a catalyst to decompose hydrogen peroxide.

In Step S12, when the plasma 115 is brought into contact with the water 110 to be plasma-treated, microbubbles and nanobubbles are formed due to evaporation of the water 110 and vaporization of the water 110 accompanied with formation of shock waves. As a result, the plasma-treated water contains microbubbles, each of which has a diameter of 1 μm or more and 100 μm or less, and nanobubbles, each of which has a diameter of less than 1 μm. The active carbon has pores having a diameter (i.e., pore size) of about 1 μm. Therefore, in the filtering step (Step S21), the active carbon removes (i.e., captures) the microbubbles by using the pores of the active carbon. However, it is considered that the nanobubbles, whose diameter is less than 1 μm, are not removed by the active carbon when the plasma-treated water passes through the active-carbon treatment unit 10.

In the above-described manner, in Step S21, the plasma-treated water is filtered through the active carbon disposed inside the active-carbon treatment unit 10. Specifically, the active carbon in the active-carbon treatment unit 10 decomposes hydrogen peroxide in the plasma-treated water and removes the microbubbles in the plasma-treated water.

The ultrasonic treatment unit 20 applies ultrasound to the plasma-treated water which has been filtered through the active-carbon treatment unit 10 (Step S22).

The ultrasound causes unstable compounds such as hydrogen peroxide to undergo a chemical reaction. For example, the ultrasound causes hydrogen peroxide to decompose into water and oxygen. Thus, when hydrogen peroxide remains or is generated in the filtered plasma-treated water, it is possible to decompose the hydrogen peroxide into water and oxygen by applying ultrasound to the plasma-treated water.

As described above, when the plasma 115 is brought into contact with the water 110 to be plasma-treated in Step S12, microbubbles and nanobubbles are formed due to evaporation of the water 110 and vaporization of the water 110 accompanied with formation of shock waves. While the microbubbles are captured by the active carbon when the plasma-treated water passes through the active-carbon treatment unit 10 in Step S21, it is considered that the nanobubbles are not captured by the active carbon in Step S21. In other words, the plasma-treated water may be, after filtered through the active-carbon treatment unit 10, still contain the nanobubbles. The ultrasound is capable of removing the nanobubbles in the plasma-treated water which has been filtered through the active-carbon treatment unit 10.

As described above, in Step S22, the ultrasonic treatment unit 20 applies ultrasound to the plasma-treated water which has been filtered through the active-carbon treatment unit 10. Specifically, the ultrasonic treatment unit 20 decomposes hydrogen peroxide contained in the plasma-treated water which has been filtered through the active-carbon treatment unit 10 by using ultrasound. The ultrasonic treatment unit 20 can remove the nanobubbles contained in the plasma-treated water by applying ultrasound to the plasma-treated water which has been filtered through the active-carbon treatment unit 10.

As described above, in the detoxification device 1, the active-carbon treatment unit 10 decomposes hydrogen peroxide and removes the microbubbles and the ultrasonic treatment unit 20 decomposes hydrogen peroxide and removes the nanobubbles.

### [3. Advantageous Effects]

An example of the advantageous effects of the detoxification device 1 according to the embodiment is described below in detail with reference to FIG. 6.

FIG. 6 is a diagram for explaining the advantageous effects of the detoxification device 1 according to the embodiment. Water containing 0.25 mM of sodium hydrogencarbonate, 0.25 mM of calcium chloride dihydrate, 0.25 mM of magnesium sulfate heptahydrate, and 0.025 mM of potassium hydrogencarbonate was used as a model of the water 110 to be plasma-treated. In the liquid treatment apparatus 100 (excluding the detoxification device 1) illustrated in FIG. 1, models (100 ml) of the water 110 were each treated with plasma to produce a 100 ml of plasma-treated water sample. The plasma-treated water samples were each treated by the application of ultrasound and/or by being filtered through active carbon as illustrated in FIG. 6. The data illustrated in FIG. 6 (except for data denoted by “x”) each represent a change in the hydrogen peroxide concentration in the corresponding one of the plasma-treated water samples with the time during which the plasma-treated water sample was left standing after being treated by the application of ultrasound and/or by being filtered through active carbon.

The data denoted by “x” represent the hydrogen peroxide concentrations in a plasma-treated water sample that was not subjected to any treatment. The data denoted by “*” represent the hydrogen peroxide concentrations in a plasma-treated water sample to which ultrasound was applied for 10 minutes in the ultrasonic treatment unit 20. The data denoted by “+” represent the hydrogen peroxide concentrations in a plasma-treated water sample to which ultrasound was applied for 60 minutes in the ultrasonic treatment unit 20. The data denoted by “⋄” represent the hydrogen peroxide concentrations in a plasma-treated water sample which has been filtered through active carbon in the active-carbon treatment unit 10. The data denoted by “□” represent the hydrogen peroxide concentrations in a plasma-treated water sample to which ultrasound was applied for 10 minutes in the ultrasonic treatment unit 20 and which was subsequently filtered through active carbon in the active-carbon treatment unit 10. The data denoted by “Δ” represent the hydrogen peroxide concentrations in a plasma-treated water sample to which ultrasound was applied for 60 minutes in the ultrasonic treatment unit 20 and which was subsequently filtered through active carbon in the active-carbon treatment unit 10. The data denoted by “◯” represent the hydrogen peroxide concentrations in a plasma-treated water sample which was filtered through active carbon in the active-carbon treatment unit 10 and to which ultrasound was subsequently applied for 10 minutes in the ultrasonic treatment unit 20. Thus, the data denoted by “◯” represent the hydrogen peroxide concentrations in a plasma-treated water sample passed through the detoxification device 1. The hydrogen peroxide concentration in each of the plasma-treated water samples was determined by taking three 5-ml aliquots of 100 ml of the plasma-treated water sample that have been subjected to the treatments illustrated in FIG. 6, measuring the hydrogen peroxide concentrations in the three aliquots by titration with potassium permanganate (JIS K-1463), and taking the average thereof.

The hydrogen peroxide concentration in the plasma-treated water sample that was not subjected to any treatment (corresponding to the data denoted by “×”) was about 15 ppm. The plasma-treated water sample contained hydrogen peroxide. Furthermore, the hydrogen peroxide concentration in the plasma-treated water sample that was not subjected to any treatment increased with time. This is presumably because the above-described microbubbles and nanobubbles in the plasma-treated water sample generated hydrogen peroxide with time and thereby increased the hydrogen peroxide concentration in the plasma-treated water sample.

The hydrogen peroxide concentration in the plasma-treated water sample to which ultrasound was applied for 10 minutes in the ultrasonic treatment unit 20 (corresponding to the data denoted by “*”) was about 13 ppm. This plasma-treated water sample had a lower hydrogen peroxide concentration than the above plasma-treated water sample that was not subjected to any treatment. This confirms that applying ultrasound to the plasma-treated water sample caused hydrogen peroxide to decompose. However, even after ultrasound had been applied to the plasma-treated water sample for 10 minutes, hydrogen peroxide remained in the plasma-treated water sample. This is presumably because a sufficiently large amount of energy was not used for decomposing hydrogen peroxide since microbubbles having a large diameter absorbed the energy of the ultrasound. Since the microbubbles absorbed the energy of the ultrasound, the nanobubbles or both nanobubbles and part of the microbubbles failed to be removed and the remaining microbubbles and/or nanobubbles generated hydrogen peroxide. Furthermore, the hydrogen peroxide concentration in the plasma-treated water sample increased with time. This is presumably because the remaining microbubbles and/or nanobubbles generated hydrogen peroxide.

The hydrogen peroxide concentration in the plasma-treated water sample to which ultrasound was applied for 60 minutes in the ultrasonic treatment unit 20 (corresponding to the data denoted by “+”) was about 11 ppm. This plasma-treated water sample had a lower hydrogen peroxide concentration than the above plasma-treated water sample to which ultrasound was applied for 10 minutes. This confirms that applying ultrasound to the plasma-treated water sample for a longer period of time caused hydrogen peroxide to decompose more. However, even after ultrasound had been applied to the plasma-treated water sample for 60 minutes, hydrogen peroxide remained in the plasma-treated water sample. This is presumably because a sufficiently large amount of energy was not used for decomposing hydrogen peroxide since microbubbles having a large diameter absorbed the energy of the ultrasound. Since the microbubbles absorbed the energy of the ultrasound, the nanobubbles or both nanobubbles and part of the microbubbles failed to be removed and the remaining microbubbles and/or nanobubbles generated hydrogen peroxide. Furthermore, the hydrogen peroxide concentration in the plasma-treated water sample increased with time. This is presumably because the remaining microbubbles and/or nanobubbles generated hydrogen peroxide.

The hydrogen peroxide concentration in a plasma-treated water sample which had been filtered through active carbon in the active-carbon treatment unit 10 (corresponding to the data denoted by “⋄”) was about 7 ppm. This plasma-treated water sample had a lower hydrogen peroxide concentration than the above plasma-treated water sample to which ultrasound was applied for 60 minutes. This confirms that filtering the plasma-treated water through active carbon caused hydrogen peroxide to decompose more than applying ultrasound to the plasma-treated water sample for 60 minutes. However, even after the plasma-treated water sample had been filtered through active carbon, hydrogen peroxide remained in the plasma-treated water sample. Thus, it is considered that hydrogen peroxide was not decomposed by the active carbon to a sufficient degree. It is considered that, while the microbubbles were removed by the active carbon, the nanobubbles were not removed and remained and the remaining nanobubbles generated hydrogen peroxide. Furthermore, the hydrogen peroxide concentration in the plasma-treated water sample increased with time. This is presumably because the remaining nanobubbles generated hydrogen peroxide.

The hydrogen peroxide concentration in a plasma-treated water sample to which ultrasound was applied for 10 minutes in the ultrasonic treatment unit 20 and which was subsequently filtered through active carbon in the active-carbon treatment unit 10 (corresponding to the data denoted by “□”) was about 4 ppm. This plasma-treated water sample had a lower hydrogen peroxide concentration than the above plasma-treated water sample which had been filtered through active carbon. However, even after the plasma-treated water sample had been treated in the ultrasonic treatment unit 20 and the active-carbon treatment unit 10 in this order, hydrogen peroxide remained in the plasma-treated water sample. This is presumably because the energy of the ultrasound was absorbed by microbubbles having a large diameter, which reduced the degree of decomposition of hydrogen peroxide which was performed using ultrasound. Furthermore, the hydrogen peroxide concentration in the plasma-treated water sample increased with time. This is presumably because, even after ultrasound had been applied to the plasma-treated water sample and the plasma-treated water sample had been subsequently filtered through active carbon, the nanobubbles remained in the plasma-treated water sample and the remaining nanobubbles generated hydrogen peroxide with time.

The hydrogen peroxide concentration in a plasma-treated water sample to which ultrasound was applied for 60 minutes in the ultrasonic treatment unit 20 and which was subsequently filtered through active carbon in the active-carbon treatment unit 10 (corresponding to the data denoted by “Δ”) was about 4 ppm. This plasma-treated water sample had the same hydrogen peroxide concentration as the above plasma-treated water sample to which ultrasound was applied for 10 minutes in the ultrasonic treatment unit 20 and which was subsequently filtered through active carbon in the active-carbon treatment unit 10. This confirms that, in the case where the plasma-treated water sample was treated in the ultrasonic treatment unit 20 and the active-carbon treatment unit 10 in this order, it was not possible to sufficiently decompose hydrogen peroxide contained in the plasma-treated water sample even when the length of time during which ultrasound was applied to the plasma-treated water sample was increased. Furthermore, even when the length of time during which ultrasound was applied to the plasma-treated water sample was increased, the hydrogen peroxide concentration in the plasma-treated water sample increased with time. This is presumably because, even after ultrasound had been applied to the plasma-treated water sample for a long period of time and the plasma-treated water sample had been subsequently filtered through active carbon, the nanobubbles remained in the plasma-treated water sample and the remaining nanobubbles generated hydrogen peroxide with time.

The hydrogen peroxide concentration in a plasma-treated water sample which was filtered through active carbon in the active-carbon treatment unit 10 and to which ultrasound was subsequently applied for 10 minutes in the ultrasonic treatment unit 20 (corresponding to the data denoted by “◯”) was 0 ppm. That is, hydrogen peroxide in this plasma-treated water sample was sufficiently removed. Furthermore, the hydrogen peroxide concentration in the plasma-treated water sample did not increase with time. This is presumably because of the following reason. The microbubbles were removed when the plasma-treated water sample was filtered through the active carbon. The nanobubbles were subsequently removed without the negative impact produced by the microbubbles when ultrasound was applied to the plasma-treated water sample. As a result, the likelihood of hydrogen peroxide being generated by the microbubbles and nanobubbles was reduced.

The detoxification device 1 according to the above-described embodiment is capable of decomposing hydrogen peroxide contained in the plasma-treated water. In addition, since the detoxification device 1 also removes the microbubbles and the nanobubbles contained in the plasma-treated water, hydrogen peroxide is not generated in the plasma-treated water with time. Thus, it is possible to sufficiently remove hydrogen peroxide contained in the plasma-treated water.

### Other Embodiments

A device and a method for detoxifying plasma-treated water according to an embodiment are described above. However, the present disclosure is not limited by the foregoing embodiment. It is to be noted that various changes and modifications are apparent to those skilled in the art and components used in the different embodiments may be used in combination with one another. Such changes and modifications are to be understood as included within the scope of the present invention as defined by the appended claims without departing therefrom.

In the foregoing embodiment, the liquid treatment apparatus 100 includes the feed pump 105, and the plasma 115 is generated inside the bubble 116 formed by a gas fed by the feed pump 105. However, the structure of the liquid treatment apparatus 100 is not limited to this. For example, the liquid treatment apparatus 100 may not include the feed pump 105. For example, plasma may be generated in bubble formed by instantaneously vaporizing a liquid by using flash boiling.

In the foregoing embodiment, the detoxification device 1 includes the active-carbon treatment unit 10. However, the structure of the detoxification device 1 is not limited to this. For example, the detoxification device 1 may include, instead of the active-carbon treatment unit 10, a filter treatment unit 10 including a filter through which microbubbles having a diameter of 1 μm or more can be removed or captured. Specifically, the average diameter of circles inscribed in pores or slits formed in the filter may be 10 μm or less or 5 μm or less. Examples of a material of the filter include polypropylene, nylon, polyether sulfone, tetrafluoroethylene, polyvinylidene fluoride, and cellulose acetate.

In the foregoing embodiment, the plasma-treated water is filtered through active carbon in the active-carbon treatment unit 10, and ultrasound is subsequently applied to the plasma-treated water for 10 minutes in the ultrasonic treatment unit 20. However, the operation of the detoxification device is not limited to this. For example, the length of time during which ultrasound is applied to the plasma-treated water may be set to be less than 10 minutes or more than 10 minutes depending on the hydrogen peroxide concentration in the plasma-treated water.

A device according to an embodiment of the present disclosure comprises: active carbon disposed at a point through which plasma-treated water passes, the plasma-treated water containing hydrogen peroxide which has been produced by generation of plasma in or near water; and an ultrasound generator, disposed downstream of the active carbon, configured to apply ultrasound to the plasma-treated water filtered through the active carbon.

Various changes, replacement, addition, and omission may be made in the foregoing embodiment within the scope of the appended claims and scopes equivalent thereto.

The device and the method for detoxifying plasma-treated water according to an embodiment of the present disclosure may be applied to a detoxification device that detoxifies plasma-treated water containing hydrogen peroxide, such as a water purification apparatus, or a water discharging apparatus, for example.

What is claimed is:

1. A method comprising:
filtering plasma-treated water containing hydrogen peroxide which has been produced by generation of plasma in or near water; and
applying ultrasound to the plasma-treated water after the filtering.

2. The method according to claim 1,
wherein, in the filtering, the plasma-treated water is filtered through active carbon.

3. The method according to claim 2,
wherein the plasma-treated water further contains microbubbles having a diameter of 1 μm or more, and
wherein, in the filtering, the active carbon removes the microbubbles by using pores in the active carbon.

4. The method according to claim 2,
wherein the plasma is generated inside a bubble which is formed by a gas fed into the water.

5. The method according to claim 1,
wherein, in the filtering, the plasma-treated water is filtered through a filter.

6. The method according to claim 5,
wherein the plasma-treated water further contains microbubbles having a diameter of 1 μm or more, and
wherein, in the filtering, the filter removes the microbubbles by using pores or slits formed in the filter.

7. The method according to claim 5,
wherein the plasma is generated inside a bubble which is formed by a gas fed into the water.
